(19) United States
(12) Patent Application Publication
(10) Pub. No.: US 2025/0021728 A1
(43) Pub. Date: Jan. 16, 2025

(54) AN INTERACTIVE TOP-DOWN EMISSIONS MODEL AND METHODS OF GENERATING THEREOF

(71) Applicant: ComboCurve, Inc., Houston, TX (US)

(72) Inventors: Vahid Shabro, Houston, TX (US); Douglas Joseph McMaster, Houston, TX (US); Brennan Michael Medina, Houston, TX (US); Ben William Sullivan, Houston, TX (US); Zidong Liu, Houston, TX (US); Daniel Perez Alvarez, Houston, TX (US); Brandon Michael Lowe, Houston, TX (US); Cameron McMaster, Houston, TX (US); Daniel Martin Burt, Cochrane, AB (CA)

(73) Assignee: ComboCurve, Inc., Houston, TX (US)

(21) Appl. No.: 18/220,113

(22) Filed: Jul. 10, 2023

(51) Int. Cl. G06Q 30/018; G06Q 50/26

(52) U.S. Cl. CPC G06F 30/28; G06F 3/04842; G06F 30/20; G06Q 10/06375; G06Q 50/26; G06F 3/04847; G06F 2113/08; Y02P 90/845

(57) ABSTRACT

An interactive top-down emissions model, and methods of generating thereof, are disclosed. An example method comprises: receiving reference emissions reports respectively associated with an organization, a basin, or a facility. Each reference emissions report indicates reference emissions data associated with the organization, the basin, or the facility over a predefined time period. Facility information indicating ownership history and/or placement history of facilities are also received. The method further includes mapping each organization to one or more basins, and each basin to one or more facilities; and generating, based on the mapping, an interactive top-down emissions model for emissions over a time period, the interactive top-down emissions model indicating one or more aggregate emissions data corresponding to the emission categories for each of a plurality organizations, each of a plurality of basins, or each of a plurality of facilities and the interactive top-down emissions model indicating relations between entered data.

### BACKGROUND

The United States Environmental Protection Agency (US EPA) established the Greenhouse Gas Reporting Program (GHGRP) in order to facilitate accurate and timely data essential for informing future climate policy decisions. For example, the reporting is intended to help EPA, states, and the public better understand emissions from specific industries, emissions from individual facilities, factors that influence greenhouse gas emission rates, and actions that facilities could take to reduce emissions. GHGRP is often required to be reported by individual organizations (e.g., companies, states, governmental bodies, etc.) and/or facilities (e.g., wells, machines, components, equipment, functions, etc.) used in various geographies (e.g., basins or other areas of resource extraction).

Conventional methodologies for calculating and reporting GHGRP and/or other required regulatory reports often rely on a “bottom-up” approach for estimating emissions. A “bottom-up” estimate may be derived from compiling an inventory of facilities and estimating the associated emissions for each facility. Models based on such approaches typically require a detailed knowledge of the equipment inventory and activities within each facility and detailed knowledge of emission parameters for each equipment in each facility, and are typically limited to pre-defined sources of emissions in the methodology. The bottom-up approach does not account for all sources of emissions, as such estimates are limited to known emission sources and/or facilities. Therefore, some methodologies for reporting GHGRP complement the bottom-approach with a monitoring approach for measuring emissions, which relies on direct measurement of emissions from an organization, facility, or geography. However, emission monitoring methodologies are expensive, and involve time intensive operations (e.g., using drones, cameras, satellites, etc.) to obtain the necessary emissions data.

Thus, obtaining emissions data often takes weeks, if not months, in order to provide GHGRP and other regulatory reporting. Entities that are subject to reporting requirements gather these data each year to allow for modeling their past and current emissions. Such entities are increasingly required to model and forecast their future emission by their investors and stakeholders. The forecasted emissions predict an estimated reporting each entity will be required to file at later years. These forecasted emissions show the progress toward emission targets set by the government or internal goals and affects entities' cash flow in the future through application of emission taxes, regulatory fees, or emission caps. When implementing a bottom-up approach for estimating future emissions, the process of obtaining emissions data as future activities are being planned renders the approach intractable. The bottom-up approach's reliance on a detailed knowledge of the equipment inventory and activities and knowledge of emission parameters for each equipment in each facility makes the bottom-up approach an unmanageable approach to apply to hypothesized future activities. The emissions monitoring approach does not overcome the problems posed by the bottom-up approach as the emissions monitoring approach is limited to past and current emissions.

Furthermore, the bottom-up approach is limited to pre-defined sources of emissions in the methodology. To include additional sources of emission, one must find and implement new accepted methods to calculate those emissions. This process could take months or years to achieve, which causes delay in modeling current emissions and understanding the future emissions.

As emission metrics are important for corporate success, entities prefer to compare their emission metrics with comparable cases to benchmark their efficiencies. However, emission modeling requires detailed knowledge of facilities and activities of other companies. As a result, the emission benchmarking to date is limited to comparing past emissions among various entities at an aggregated level and at an absolute emission level.

There is therefore a desire and need for a system and method that allows for comparing emissions at any aggregation level and at absolute and intensity levels for the past, present and future. There is also a desire and need for a more accurate, reliable, and efficient system and method for preparing comprehensive models for emissions data. Various embodiments of the present disclosure address one or more of the above described shortcomings.

### SUMMARY

The present disclosure provides systems and methods for efficiently generating a more effective and accurate top-down emissions model, which is also interactive to allow the user to adapt the top-down emissions model to their needs or circumstances. In an embodiment, a method of generating an interactive top-down emissions model is disclosed. The method may include receiving, by a computing device having a processor, a plurality of reference emissions reports. Each reference emissions report may be respectively associated with an organization, a basin, or a facility, among a plurality of organizations, a plurality of basins, or a plurality of facilities, respectively. Each reference emissions report may indicate one or more reference (e.g., prior) emissions data associated with the organization, the basin, or the facility over a predefined (e.g., a desired) time period. The method may further include receiving, by the computing device, facility information indicating, for each of a plurality of facilities, one or both of: an ownership history of the facility during a first time period, or a placement history of the facility during the first time period. The ownership history may indicate ownership of the facility by one or more organizations, among the plurality of organizations. The placement history may indicate an association of the facility with one or more basins among the plurality of basis. The method may further include mapping, via a mapping module of the computing device, and based on the plurality of reference emissions reports and the facility information, each organization, of the plurality of organizations, to one or more basins among the plurality of basins, and each basin, of the plurality of basins, to one or more facilities among the plurality of facilities. The method may further include generating, by the computing device, and based on the mapping, an interactive top-down emissions model for emissions over a second time period. The interactive top-down emissions model may indicate one or more aggregate emissions data corresponding to the one or more emission categories for each of the plurality organizations, each of the plurality of basins, or each of the plurality of facilities.

In another embodiment, system for generating an interactive top-down emissions model (e.g., for performing a top-down emissions control) is disclosed. The system may comprise: a processor; a mapping module; and a memory. The memory may store instructions which, when executed by the processor, cause the processor to perform one or more steps, processes, or methods described herein. For example, the method may include: receiving a plurality of reference emissions reports, wherein each reference emissions report is respectively associated with an organization, a basin, or a facility, among a plurality of organizations, a plurality of basins, or a plurality of facilities, respectively, wherein each reference emissions report indicates one or more reference emissions data associated with the organization, the basin, or the facility over a predefined (e.g., a desired) time period. The method may further include: receiving facility information indicating, for each of a plurality of facilities, one or both of: an ownership history of the facility during a first time period, the ownership history indicating ownership of the facility by one or more organizations, among the plurality of organizations, or a placement history of the facility during the first time period, the placement history indicating an association of the facility with one or more basins among the plurality of basis. The method may further include: mapping, via the mapping module, and based on the plurality of reference emissions reports and the facility information, each organization, of the plurality of organizations, to one or more basins among the plurality of basins, and each basin, of the plurality of basins, to one or more facilities among the plurality of facilities; and generating, based on the mapping, an interactive top down emissions model for emissions over a second time period, the interactive top down emissions model indicating one or more aggregate emissions data corresponding to the one or more emission categories for each of the plurality organizations, each of the plurality of basins, or each of the plurality of facilities.

In another embodiment, a non-transitory, computer-readable medium storing instructions is disclosed. The instructions, when executed by a processor, cause the processor to perform one or more steps, processes, or methods disclosed herein. For example, a method includes receiving a plurality of reference emissions reports, wherein each reference emissions report is respectively associated with an organization, a basin, or a facility, among a plurality of organizations, a plurality of basins, or a plurality of facilities, respectively, wherein each reference emissions report indicates one or more reference emissions data associated with the organization, the basin, or the facility over a predefined (e.g., a desired) time period. The method further includes receiving facility information indicating, for each of a plurality of facilities, one or both of: an ownership history of the facility during a first time period, the ownership history indicating ownership of the facility by one or more organizations, among the plurality of organizations, or a placement history of the facility during the first time period, the placement history indicating an association of the facility with one or more basins among the plurality of basis. The method further includes: mapping, via the mapping module, and based on the plurality of reference emissions reports and the facility information, each organization, of the plurality of organizations, to one or more basins among the plurality of basins, and each basin, of the plurality of basins, to one or more facilities among the plurality of facilities; and generating, based on the mapping, an interactive top down emissions model for emissions over a second time period, the interactive top down emissions model indicating one or more aggregate emissions data corresponding to the one or more emission categories for each of the plurality organizations, each of the plurality of basins, or each of the plurality of facilities.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a flowchart of an example process for generating an interactive top-down emissions model, according to an example embodiment of the present disclosure.

FIG. 1B is a flowchart of an example process for integrating emissions data across emissions categories to provide varied levels of granularity in the interactive top-down emissions model, according to an example embodiment of the present disclosure.

FIG. 2 is an example user interface showing a table of the interactive top-down emissions model listing emissions categories and corresponding emissions data, according to an example embodiment of the present disclosure.

FIG. 3 is an example user interface for importing reference emissions reports, according to an example embodiment of the present disclosure.

FIG. 4 is an example user interface for inputting emissions values, according to an example embodiment of the present disclosure.

FIG. 5 is an example user interface showing a filtering of emission categories of the interactive top-down emissions model, according to an example embodiment of the present disclosure.

FIG. 6 is an example user interface showing an incorporation of the interactive top-down emission model along with a detailed network emission model, according to an example embodiment of the present disclosure.

FIG. 7 is an example user interface showing the modification of emission categories in the interactive top-down emissions model, according to an example embodiment of the present disclosure.

FIGS. 8-18 are screenshots illustrating various emissions data from the interactive top-down emissions model, according to an example embodiment of the present disclosure.

FIG. 19 is a block diagram of an example computing device and network for generating an interactive top-down emissions model, according to an example embodiment of the present disclosure.

### DETAILED DESCRIPTION

As previously discussed, there is a desire and a need for a more accurate, reliable, and efficient system and method for preparing comprehensive models for emissions data. Such comprehensive data is needed to provide corporations, investors, the EPA, the states, and the public with a better understanding of emissions from specific industries, organizations, facilities, and geographies to perform actions or enact policies to reduce or control emissions. However, conventional methods of generating emissions models are laborious and time-intensive, as they rely on calculations based on individual source of emission. Furthermore, the compilation of individual reports, which often use inconsistent terms, names, and/or units, or often rely on data obtained from different time periods, result in inaccurate, erroneous, and unreliable data. Additionally, inconsistencies regarding how emissions are determined for each geography (e.g., site, well, etc.), facility (e.g., equipment, machine, etc.), and organization (e.g., company, state, etc.) between GHGRP and other regulatory reports make it difficult for the EPA and other organizations to conduct meaningful comparisons.

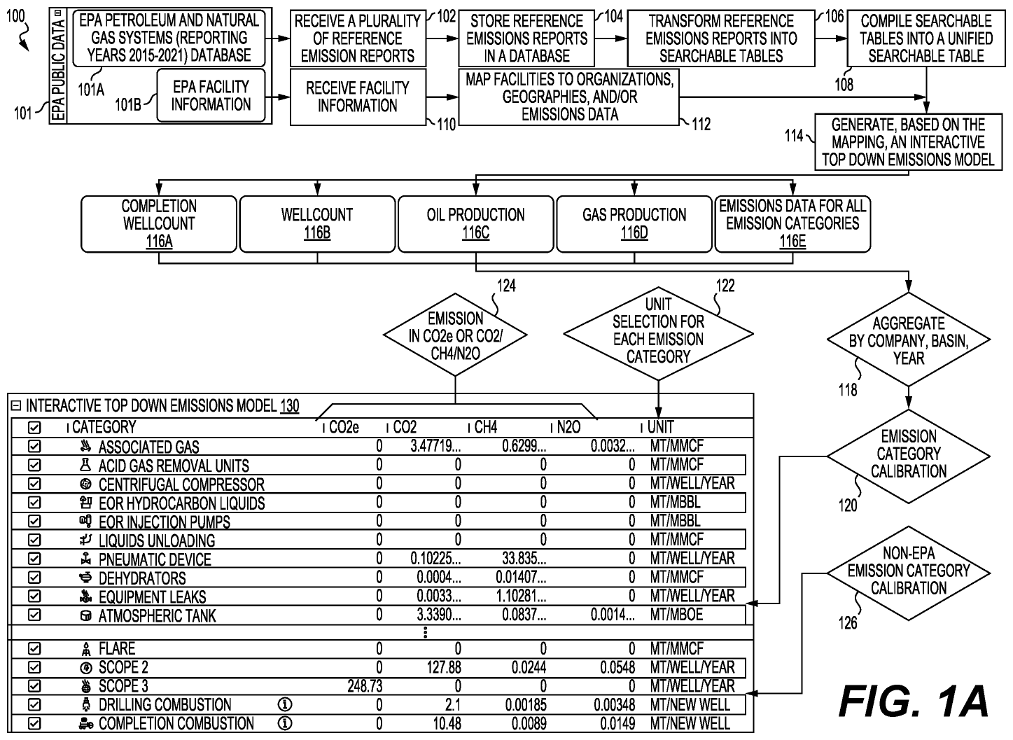

The present disclosure provides a system and method for generating a top-down emissions model, for example, to perform emissions controls, to model emissions in industries, organizations, facilities, or geographies (e.g., basins), and/or to simulate and forecast emissions. FIG. 1A illustrates a flowchart of an example process 100 for generating a top-down emissions model 130, according to an example embodiment of the present disclosure. Process 100 may be performed by a computing device having one or more processors. In some embodiments, the computing device may have a memory or other storage device with computer readable instructions that may be executed by the processor to perform one or more steps or methods of process 100.

Process 100 may begin by receiving (e.g., importing and/or downloading) a plurality of emission reports (block 102). The emission reports may be received from an external database or server associated with a facility or an organization (e.g., a company, a state body, etc.). For example, the emissions reports may be received (e.g., electronically) from the Petroleum and Natural Gas Systems database 101A of the Environmental Protection Agency (EPA) Public Database 101 (referred to herein and shown in FIG. 1A as “EPA Public Data” 101). Although the EPA is used as an example of a governmental body having a database for emissions reports, it is contemplated that emissions reports may be received from other external sources. In some embodiments, these reports may be received from non-EPA or non-governmental databases or sources. Furthermore, although block 102 indicates that emissions report is received, emissions report is merely an example of a form of emissions-related information that may be received. For simplicity, the term emissions report, as used herein, may also refer to any of the alternative forms of electronic storage of emissions-related information (e.g., raw data of emissions values for a given geography, facility, or organization). For example, in at least one aspect, emissions reports may be in the form of emissions data received from sensors (e.g., geospatial devices or satellites). Thus, it is contemplated that any form of emissions-related information, in the form of any compilation of any emissions data or data structure, from any database or external source that provides emission-related information for one or more facilities, one or more geographies, and/or one or more organizations, or an aggregation of facilities, geographies, and/or organizations, may be received.

The received emissions reports, referred to herein as “reference emissions reports, may be from disparate or varied time periods. In some embodiments, the reference emissions reports may be from a time period prior to that at which the reference emissions reports are received. For example, each reference emissions report may indicate one or more prior emissions data associated with an organization, geography (e.g., a basin or other geographic source for an extractable resource), or the facility over a prior time period. Also or alternatively, the reference emissions reports may be received responsive to a user request for emissions reports from a desired time period in the past, present (e.g., ongoing), or future (e.g., a forecast).

In some embodiment, the computing device may receive the plurality of available reference emission reports for a plurality of companies, a plurality of facilities, a plurality of basins, a plurality of available years, and/or a plurality of emission categories in XML format. The computing device may import such reference emissions reports using a crawling software (e.g., within the permissions set by the sending server or database) to scrape the data. The received reports may be stored and/or organized in the computing device (e.g., as XML files in a database) (block 104). In some embodiments, the computing device may transform the stored plurality of emissions reports (e.g., XML files) into a plurality of respective searchable tables (block 106). Furthermore, the computing device may compile the plurality of searchable tables into a single unified and searchable emission report (block 108).

The process 100 may further include receiving, by the computing device, facility information for each of a plurality of facilities associated with the received emissions data (block 110). For example, in at least one embodiment, facility information may be imported and/or downloaded for a plurality of organizations (e.g., companies), a plurality of facilities, a plurality of geographies (e.g., basins or other areas for resource extraction), and/or a plurality of available years into CSV files. The facility information may include, for example, ownership information (e.g., ownership history) for facilities associated with the emissions data during a time period that overlaps with the time period associated with the emissions data. Also or alternatively, the facility information may include placement information (e.g., placement history) of the facility during a time period that overlaps with the time period associated with the emissions data. The ownership history may indicate ownership of the facility by one or more organizations, among the plurality of organizations. The placement history may indicate an association of the facility with one or more basins among a plurality of basins. In some embodiments, the facility information may be received from an external database or server associated with a facility or an organization (e.g., a company, a state body, etc.). For example, the facility information may be received (e.g., electronically) from the EPA Facility Information Database 101B of the EPA Public Database 101.

The process 100 may further include mapping, based on the plurality of received emissions reports and the facility information, the facilities to organizations, geographies, and/or emissions data (block 112). For example, each organization, of the plurality of organizations from the received emission reports, may be mapped to one or more basins among the plurality of basins from the received emissions reports. Furthermore, each basin, of the plurality of basins, may be mapped to one or more facilities among the plurality of facilities from the received emissions report. In some embodiments, the computing device may perform the mapping using a mapping module of the computing device. In some embodiments, the mapping may create, within a data structure of a unified database for emissions data, one entry by company, basin, and years of ownership, for all facilities referenced in the received facility information. The mapping module may comprise a software and/or hardware subcomponent of the computing device configured to map and/or reconfigure associations between stored data, for example, to switch store data from a first data structure or data type to a second data structure.

In some aspects, the mapping may correct inconsistencies or errors based on organizations, facilities, geographies, emissions categories, and emissions data. For example, the computing device may determine, based on the received facility information, that there is a change in ownership of a facility from one organization (a first organization) to another organization (a second organization). The plurality of reference emissions reports received in block 102 may not have reflected that change in ownership, for example, due to the time periods associated with the received emissions report being prior to the change in ownership. Thus, the computing device may update the mapping to reflect the change in ownership. In another example, the computing device may determine, based on the received facility information, that there is a change in the placement of a facility (e.g., an oil rig) from one geography (e.g., a first basin) to another geography (e.g., a second basin). In some embodiments, in order to correct errors and inconsistencies while mapping, the computing device may extract a list of parent organizations (e.g., companies) from the received facility information and received emissions reports, and update inconsistent company names. Since company naming might not have been consistent in previous time periods, the computing device may analyze the data for inconsistency and go through facility entries from the received facility information, and match parent organizations with each facility e.g., to avoid duplicated emissions data for facilities. Furthermore, to account for ownership changes, the computing device may aggregate the emissions data from the received emissions report into a table for each facility (based on the mapping of the emissions data to the facilities) by reporting year. The computing device may then search for changes in ownership of the facilities and/or geographies (e.g., wells). The computing device may then update all ownership in all years to the owner for the last (e.g., most recent) emissions report. The resulting table may assign organization identifiers (e.g., company names) and identifiers of geographies (e.g., basins) to each facility and may aggregate the facilities by reporting year, organization name, geography (e.g., basin), and industry segment.

The process 100 may further include generating, based on the mapping, an interactive top-down emissions model 130 for emissions over a time period (block 114). The time period for the interactive top-down emissions model (referred to herein as second time period) may be, for example, an aggregate of the time periods of the received reports and/or may be a large enough time period to allow forecasting or extrapolation of time periods in the future, the current, or in a past time period not specifically covered by any of the previously received emissions report. In some embodiments, the time period may be the current time (e.g., a snapshot). The interactive top-down emissions model 130 may be rendered as “interactive” based on the compilation of the plurality of tables corresponding to the plurality of received emissions reports, into a single unified emissions table that is rendered to be searchable based on organization, facilities, geographies (e.g., wells), and emissions categories, among other aspects. The interactive top-down emissions table may also be rendered interactive based on the functionalities described as follows.

The interactive top-down emissions model 130 may indicate one or more aggregate emissions data 116E from the table corresponding to the one or more emission categories for each of the plurality organizations, each of the plurality of basins, or each of the plurality of facilities. In some aspects, the interactive top down emissions model 130 may also include information such as the number of completion wells (completion well count 116A), the number of wells (well count 116B), an amount of oil production 116C, and/or an amount of gas production 116D. Such information may be aggregated by organization (e.g., company), geography (e.g., well), facility, and/or year (e.g., as shown in block 118).

The aggregated data may be automatically converted to relevant units, and/or may automatically be linked to other data reflecting relevant components of the former data. For example, emissions data for emissions categories for greenhouse gases may be shown in metric tons (MT) (or other relevant units) of carbon dioxide (CO2), methane (CH4), nitrous oxide (N2O), etc. The total gas production may be reflected in million cubic feet (MMCF), or another other relevant unit. The total oil production may be reflected in thousand barrels (MBBL) or any other relevant unit. The total hydrocarbon production may be reflected in thousand barrels of oil equivalent (MBOE) or any other relevant unit. The well count may be reflected in the total number of operated wells in integer format. The drilling and completion well count may be reflected in the total number of drilled/completed wells (e.g., new wells) in integer format. Also or alternatively, the interactive top down emissions model 130 may be configured to allow emissions data for emissions categories to be expressed in a desired unit selected by the user (e.g., as shown in block 122).

In some embodiments, the interactive top-down emissions model 130 may be arranged by emission categories. The emission categories may comprise or may be based on existing EPA emissions categories, for example, as received from reference emissions reports, and/or non-EPA emissions categories. In some embodiments, the interactive top-down emissions model 130 may be configured to calibrate emissions data for emissions categories to various production metrics as desired by a user of the interactive top down emissions model (e.g., as shown in block 120). For example, the emissions data may be calibrated to total gas production, for example as emission/gas production, expressed in MT/MMCF, or in another relevant unit. In some aspects, the emissions data can be calibrated to total oil production, for example, as emission/oil production, expressed in MT/MBBL, or in another relevant unit. In another aspect, the emissions data can be calibrated to total hydrocarbon production, for example as emission/hydrocarbon production, expressed in MT/MBOE, or in another relevant unit. In another aspect, the emissions data can be calibrated to well count, for example, as emission/well count, and expressed in MT/Well/Year, or in another relevant unit. In another aspect, the emissions data can be calibrated to a number of new (e.g., completed) wells, for example, as emission/new well count, and expressed in MT/new well or in another relevant unit. The interactive top-down emissions model 130 may also arrange and/or calibrate emissions data for non-EPA emissions categories (e.g., emissions categories not found or recognized within reports published by the EPA) (e.g., as shown in block 126). The non-EPA emissions categories may include but are not limited to: Scope 2 emissions, Scope 3 emissions, drilling combustion, or completion combustion.

In some embodiments, the interactive top-down emissions model 130 may be configured to express emissions and/or production data in various units or equivalents as desired by a user. For example, emission values may be expressed as CO2 equivalents (CO2e) or a relevant units of specific greenhouse gases (e.g., CO2, CH4, and N2O) (e.g., as shown in block 124).

FIG. 1B is a flowchart of an example process for integrating emissions data across emissions categories to provide varied levels of granularity in the interactive top-down emissions model, according to an example embodiment of the present disclosure. The presently described interactive top-down emissions model enables a user to compare emissions for different facilities, geographies (e.g., wells, sites, etc.), and/or organizations (e.g., companies, states, etc.), regardless of how different the reported emissions data and/or emissions values may be. By standardizing and integrating the reported emissions data, the interactive top-down emissions model allows the user to select any given emission source (e.g., based on a specific emissions category, facility, geography, and/or organization) for more granular analysis, while allowing the user to broadly select groups of emissions source for a less granular, integrated, and/or standardized analysis. Thus, the interactive top-down emissions model (e.g., via a user interface) improves the ability of conventional systems for displaying emissions data (e.g., via user interfaces), by allowing for more efficient information presentation based on a desired level of granularity.

For example, the computing device may receive reported emissions data for any emissions category (e.g., block 152), and then may convert the total emissions reported for the emissions category in metric tons (MT) (or another relevant or desired unit) (block 154). The emissions data may include one or more emission values for a specific emission source from a reference emissions report. The reported emission data may not be in units that are consistent with the units used for other reported emissions data in the same or similar emissions category. For example, the computing device may have received (e.g., from a reference emissions report), an emission value for an associated gas in a given facility in a given basin operated by a given company in a given year as being 50% of the organization's total emissions value. In the example, the computing device may have also received (e.g., from the same or another reference emissions report) emissions data indicating that the organization emitted X metric tons (MT) of CO2e in the given year. The computing device may automatically convert and store the total emissions reported for the emission category of associated gas (for the company for the given year) as 0.5X metric tons (MT) of CO2e.

Also or alternatively, a user planning to acquire, modify, and/or eliminate an emission source, and may cause the computing device to receive the reported emissions data for emissions forecasting. For example, the user may be an organization planning changes in downstream processing equipment. As these changes are likely to affect emissions data, the user may cause the computing device to receive (e.g., via selection of an import command) reported emissions data pertaining to the downstream processing equipment from a prior year, and/or reported emissions data pertaining to a new processing equipment that the user wishes to install but is currently implemented in another organization. The reported emissions data may be expressed in units or forms inconsistent with other emissions data pertaining to the user's organization. Thus, the computing device may identify the emissions category for the reported emissions data and convert the reported emissions data (of the proposed change in the downstream processing equipment) in metric tons or another relevant unit to facilitate integration.

In order to integrate emissions data across the same emissions category or across similar emissions categories (e.g., in order to avail the user with the option to view emissions data in a less granular and more efficient manner), the computing device may identify the type of emissions category of the received reported emissions data (e.g., in blocks 156, 162, 168, and 174), and then perform emission category type-specific calibrations to generate integrated emissions data.

For example, the computing device may determine whether the emissions category, for which the reported emissions data is received, is one of the Associated Gas, Acid Gas Removal, Liquid Unloading, Dehydrators, or Flare emissions categories (block 156). If so, the computing device may determine the total gas produced in million cubic feet (MMCF), or another other relevant unit (block 158). The computing device may then generate and store emissions data in the units of metric tons of total emissions divided by million cubic feet of total gas produced (MT/MMCF) (block 160).

If not one of the previously mentioned categories of block 156, the computing device may determine whether the emissions category is one of the Atmospheric Tanks, EOR Hydrocarbon Liquids, or EOR Injection Pumps emissions categories (block 162). If so, the computing device may determine the total oil produced in thousand barrels (MBBL), or another other relevant unit (block 164). The computing device may then generate and store emissions data in the units of metric tons of total emissions divided by the thousand barrels of total oil produced (MT/MBBL) (block 166).

If not one of the previously mentioned categories of block 162, the computing device may determine whether the emissions category is one of the Centrifugal Compressor, Reciprocating Compressor, Pneumatic Device, Pneumatic Pump, Equipment Leaks, Well Testing, Blowdown Vent Stacks, or Combustion emissions categories (block 168). If so, the computing device may determine the total number of wells in the given year (wells/year), or another other relevant unit (block 170). The computing device may then generate and store emissions data in the units of metric tons of total emissions divided by the total number of wells per year (MT/Well/Year) (block 172).

If not one of the previously mentioned categories of block 168, the computing device may determine whether the emissions category is one of the Completions With Fracturing or Completion Without Fracturing emissions categories (block 174). If so, the computing device may determine the total number of new wells, or another other relevant unit (block 176). The computing device may then generate and store emissions data in the units of metric tons of total emissions divided by the total number of new wells (MT/New Well) (block 178).

At block 180, the computing device may integrate the emissions data across emissions categories based on user preferences. For example, a user may desire to view emissions data only by category types. The interactive top-down emissions model can thus add up, and present to the user, gas related emission data in MT/MMCF, oil-related emissions data in MT/MBBL, well related missions data in MT/Well/Year, and/or new well related emissions data in MT/New Well. Also or alternatively, the interactive top down emissions model may avail the user with the option to view emissions data for a specific emissions source within a specific emissions category (e.g., oil produced for a specific atmospheric tank in the emissions category of Atmospheric Tanks). The interactive top-down emissions model may display, in the units originally reported, or in another desired unit (after automatic conversion), the emissions data for the specific emissions source.

Thus, the interactive top-down emissions model provides the user with an almost limitless flexibility in generating and/or viewing emissions data for a given geography, facility, or organization, or across multiple geographies, facilities, and/or organizations. Furthermore, the interactive top-down emissions model estimates emissions data for certain changes, such as for downstream process equipment changes or when a site is purchased by another company, and provides users with the ability to compare emissions data for different geographies, facilities, and/or organizations regardless of how different the reporting emissions data and/or units for the reported emissions data may be.

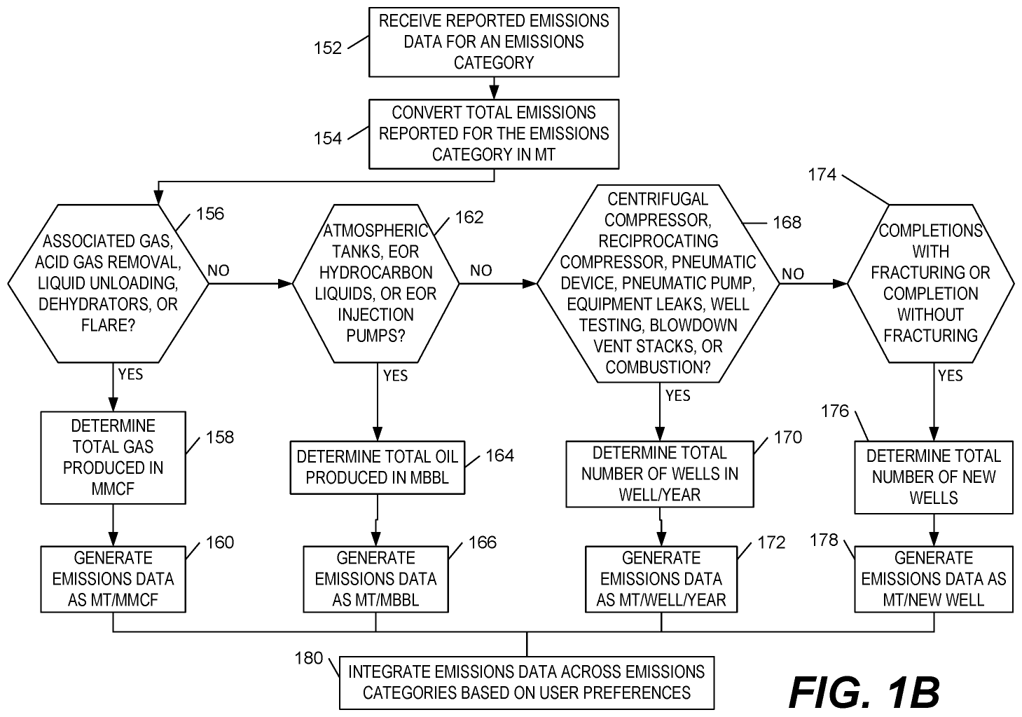

FIG. 2 is an example user interface showing a table 200 of the interactive top-down emissions model (e.g., the interactive top-down emissions model 130 of FIG. 1). As shown in table 200, the interactive top-down emissions model may list a plurality of emissions categories 200A and corresponding emissions data 200B. The interactive top-down emissions model may allow users to assign top-down (e.g., at a high level) emission estimates to various geographies (e.g., wells or other areas of resource extraction). In some aspects, these emission estimates may be assigned, using simulations of scenarios (e.g., based on new geographies). The emissions categories for the emissions data may include emission categories recognized or disclosed in the EPA's Subpart W forms. Also or alternatively, the emissions categories may cover those not specifically covered in the EPA Subpart W forms, such as Scope 2 and Scope 3 emissions categories, or emissions categories that are reported within other EPA forms, such as Drilling and Completion. Emission categories, whether recognized by the EPA or otherwise, may include but are not limited to: associated gas, acid gas removal units, centrifugal compressor, EOR hydrocarbon liquids, EOR injection pumps, liquids unloading, pneumatic device, dehydrators, equipment leaks, atmospheric tank, reciprocating compressor, completions with fracturing, drilling combustion, completion combustion, combustion, pneumatic pump, well testing, and blowdown vent stacks.

As shown in FIG. 2, the emissions data may be defined either in terms of CO2e (e.g., as shown in column 202) or in any combination of CO2, CH4, N2O (e.g., as shown in column group 204). It is contemplated that CO2e may be used as an alternative to a combination of the three greenhouse gases (e.g., CO2, CH4, N2O) since CO2e is calculated directly from those three greenhouse gases when available. The interactive top-down emissions model may be configured to allow a user to define, for each desired emissions category, the amount of gas (in a desired unit, such as metric tons (MT)) per unit of activity relevant to that emission category.

In some aspects, emissions data may be related to gas production volume, such as flare. In such aspects, the user may define the top-down emission in the units of MT/MMCF, for example. In other aspects, emissions data may depend on oil volumes, such as atmospheric tanks. In such aspects, the user may define the top-down emission for atmospheric tank in the units of MT/MBBL, for example. For some emissions categories, such as drilling and completion, emissions data may only be obtainable when a well or other resource extractor is put in use (e.g., put online), such as at or near a field development plan). For such emissions categories, the interactive top-down emissions model may be configured so that the user can define the top-down emission in units of metric tons (MT)/new well or another relevant unit. For some emissions categories, emissions data may depend on the number of wells. For example, the lighting of the pad may be required regardless of whether there are activities occurring on the pad and regardless of production volumes associated with the pad. For such emissions categories, the interactive top-down emissions model may be configured so that a user can define Scope 2 emissions data (e.g., emissions due to grid factors used for the electricity consumption from those lightings) in units of metric tons (MT)/well/year, or another relevant unit. Another unit for expressing emissions data may be metric tons (MT) per thousand barrels of oil equivalent (MT/MBOE).

As shown in column 206 of FIG. 2, the interactive top-down emissions model may be configured to apply escalation for any emissions categories, emission data, facilities, geographies, or organizations. As used herein, an escalation may refer to a simulation functionality where a user can apply desired changes to one or more of the emission data, emissions categories, facilities, geographies, or organizations of the interactive top-down emissions model. For example, a user may replace 50% of a pneumatic pump (e.g., as may be used in a facility), and the replacement may occur at a certain date (e.g., Mar. 1, 2024). The user can apply an escalation, which would replicate a 50% reduction on Mar. 1, 2024, and apply that reduction to the pneumatic pump emissions category, e.g., to obtain and/or automatically update emissions data.

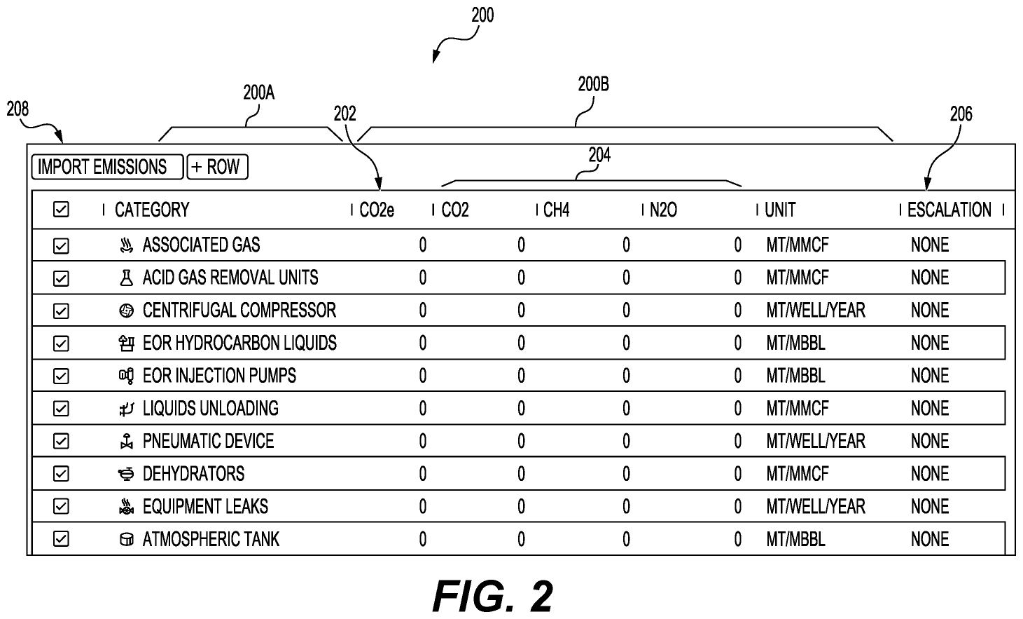

FIG. 3 is an example user interface 300 for importing reference emissions reports, such as for receiving a plurality of emissions reports from previous time periods as previously described in block 102 of FIG. 1. In some embodiments, the user may obtain the example user interface 300 shown in FIG. 3, from the example table 200 of the interactive top-down emissions model shown in FIG. 2, by selecting (e.g., clicking or tapping) “import emissions” 208. As shown in FIG. 3, the example user interface may be configured to allow the user to request reference emissions reports from a specific year or year range (e.g., as shown in box 302), a specific organization (e.g., block 304), a specific basin, and/or a specific (or all) emissions category (e.g., block 306). Since a user may be expected to perform calculations to be able to input top-down emissions data, the automated import of reference emissions reports using the user interface 300 reduces and/or eliminates these calculations. For example, the user interface 300 allows the computing device to receive and scrape all or a plurality of EPA Subpart W emissions reports for all or a plurality of available prior years (or a desired time period) for all or a plurality of organizations (e.g., oil and gas companies), in all or a plurality of geographies (e.g., basins). Furthermore, the computing device implementing the import of the reference emissions reports may be configured to perform normalization (e.g., by adjusting emissions and/or production values based on a predefined scale and/or based on desired units) to allow appropriate top-down emissions to be automatically input into a unified emissions table. In some aspects, a user (e.g., an organization) can use the user interface 300 to bring (e.g., upload) their own EPA reports (e.g., from the organization) from prior years (or another desired time period) and/or from a desired basin. Also or alternatively, a user may use the user interface 300 to cause import of (e.g., by transmitting a request for the import of) emissions reports of their neighboring operators or any other operator for comparison and benchmarking.

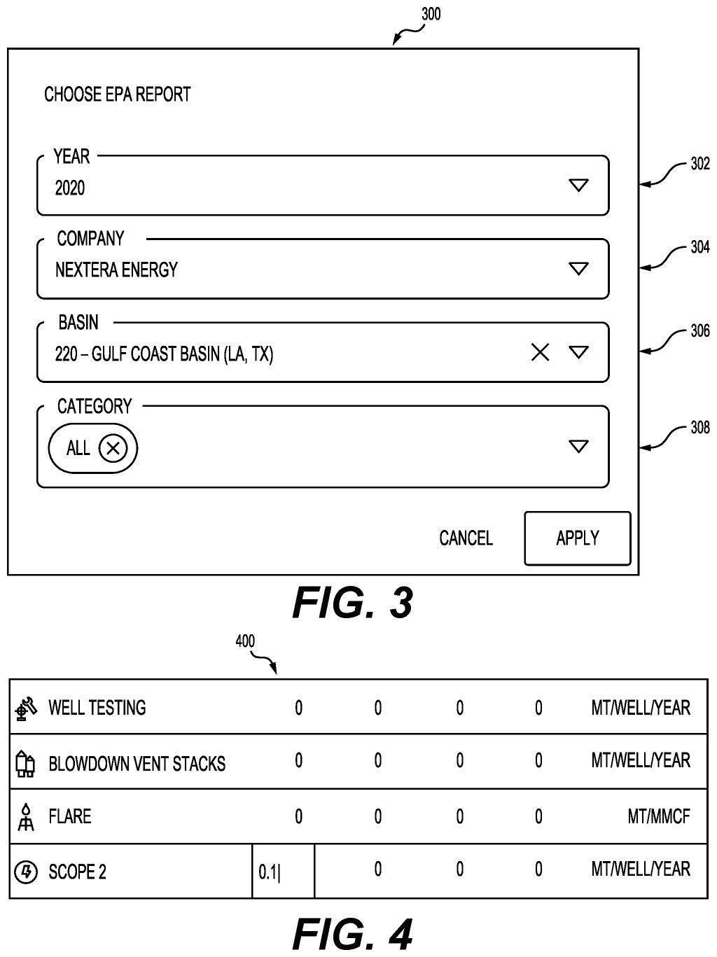

FIG. 4 is an example user interface 400 for inputting emissions values, according to an example embodiment of the present disclosure. As previously discussed, after importing the plurality of emissions reports from a prior (or a desired) time period (reference emissions reports), compiling them into unified and searchable emission reports, receiving and mapping facility information, and generating an interactive top-down emissions model (e.g., blocks 102 through 110 of FIG. 1), a user may choose to manually input, or change an automatically entered, value in the emissions data. Moreover, a user can directly input a specific value to define the emission for a specific emissions category by typing the emission value in each relevant cell. For example, as shown in user interface 400, the user has typed 0.1 MTCO2e/Well/Year in to account for what they have calculated for the electricity usage in a specific well. The electricity usage corresponds to a Scope 2 emissions category.

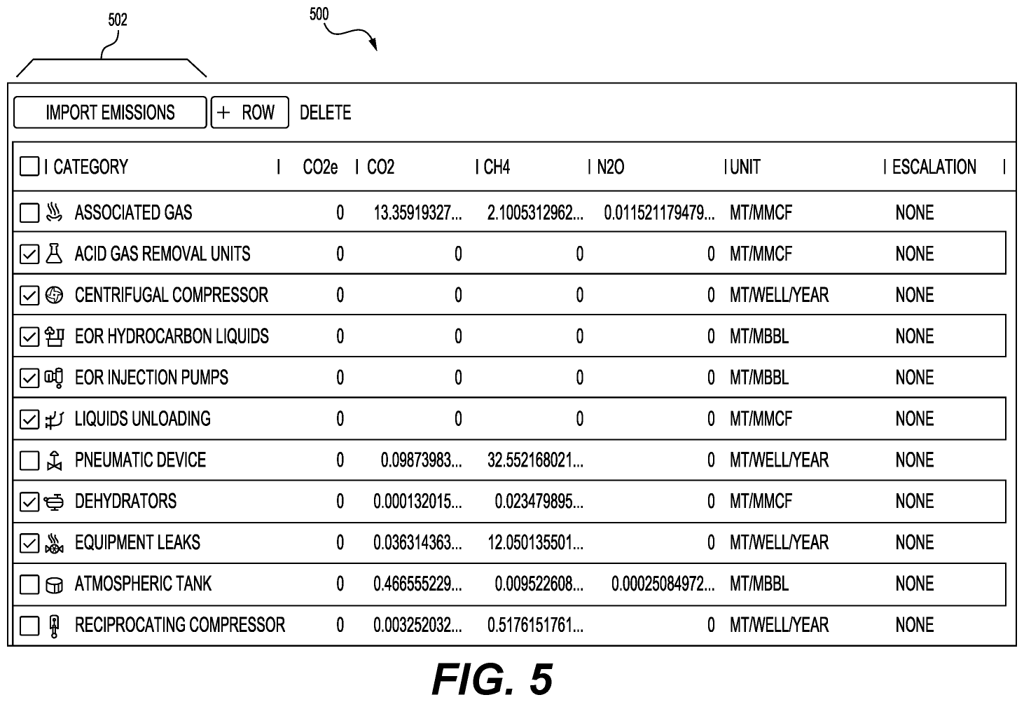

FIG. 5 is an example user interface 500 showing filtering of emission categories of the interactive top-down emissions model, according to an example embodiment of the present disclosure. The interactive top-down emissions model may be configured to allow a user to view and/or filter emissions data for a subset of organizations, a subset of facilities, a subset of geographies, and/or a subset of emissions categories. For example, the table of the interactive top-down emissions model may be populated with appropriate top-down emission values for CO2, CH4 and N2O gases in units predetermined to match the nature of each emission category. However, as shown in user interface 500, a user can toggle each emission category on or off (e.g., via marking the checkboxes shown in column 502), which makes the interactive top-down emissions model use or ignore the related row when calculating emissions data.

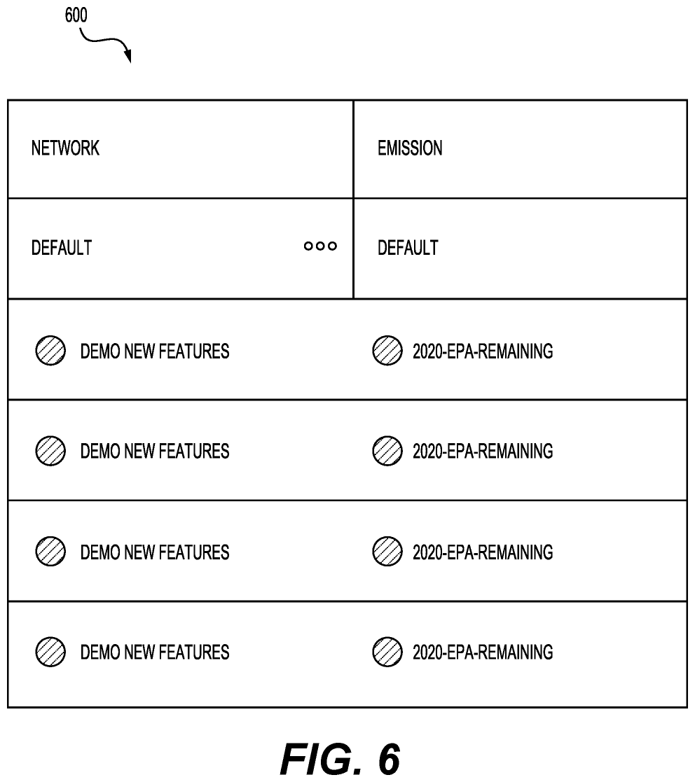

FIG. 6 is an example user interface 600 showing an incorporation of the interactive top-down emissions model in addition to a detailed emission network model, according to an example embodiment of the present disclosure. The network model may allow a user to do a detailed bottom-up modeling of emission based on various scenarios (e.g., changes to geographies and/or environments). As shown in the user interface 600, a user can select and incorporate one of a plurality of saved interactive top-down emissions model along with one of a plurality of saved network models in the user interface. Thus, the user may be able to use the interactive top-down emissions model alone, or in combination with network model. For example, a user may want to model emissions for an emission category, such as for an associated gas, a pneumatic device, an atmospheric tank, and/or a reciprocating compressor in the network model. By incorporating the interactive top-down emissions model along with the network model, the user may be able to incorporate both top-down and bottom-up approaches to estimating emissions data more accurately, effectively, and efficiently. For example, the user may desire to define bottom-up detailed calculations for those categories, but the user may desire to model Dehydrators and Equipment Leaks in the interactive top-down emissions model for completeness. The user can toggle off the emission categories that are accounted for in the network model, but keep the emissions toggled on for those emission categories of dehydrators and equipment in the interactive top-down emissions model. The user can thus be able to effectively allow the incorporated interactive top-down emissions model to apply the appropriate emissions data for each emission category, and add the appropriate emission values up in a single, unified emissions model for total emission.

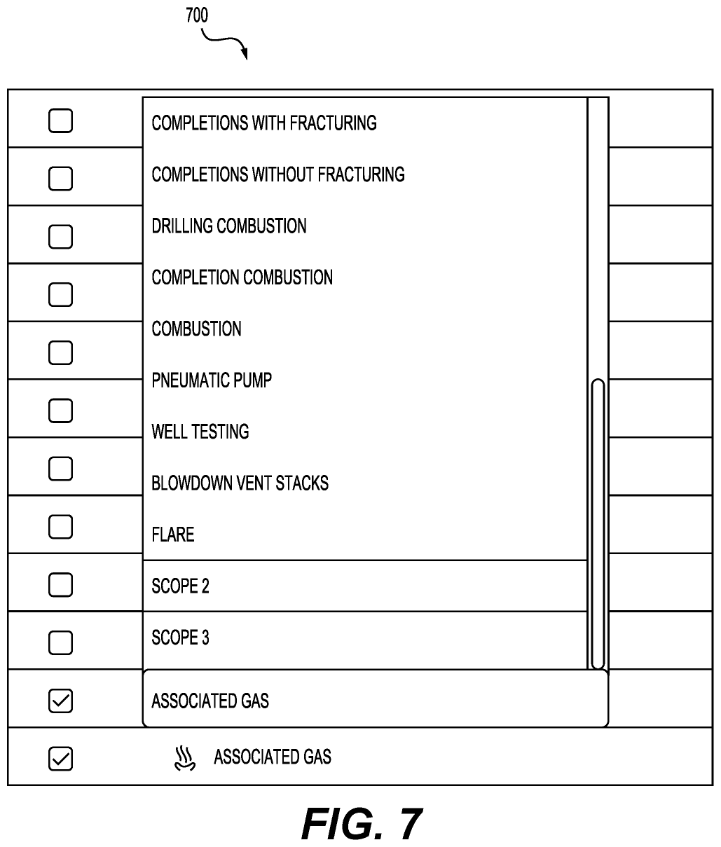

FIG. 7 is an example user interface 700 showing modification of emission categories in the interactive top-down emissions model, according to an example embodiment of the present disclosure. As shown in FIG. 7, the interactive top-down emissions model may be configured to allow modification of emission categories by providing a functionality by which a user can add additional rows for the top-down emission table. For example, the user can add the additional rows by clicking on the desired emission category and selecting (e.g., pressing or clicking) “+Row.” An additional row may be added to the bottom of the table. The user can also change an existing emission category, for example, by double-clicking it on the user interface 700 and changing the emission category to any other category. Having multiple rows for the same category may be desirable when emissions data depends on multiple factors. For example, the scope 2 emission category could be due to the electricity usage of a gas compression unit. Thus, emissions data for that emission category could be calculated in units of MT/MMCF since electricity usage in this example is related to the volume of gas processed in the facility, even though electricity (e.g., for lighting) may have been previously calculated in units of MT/well/year.

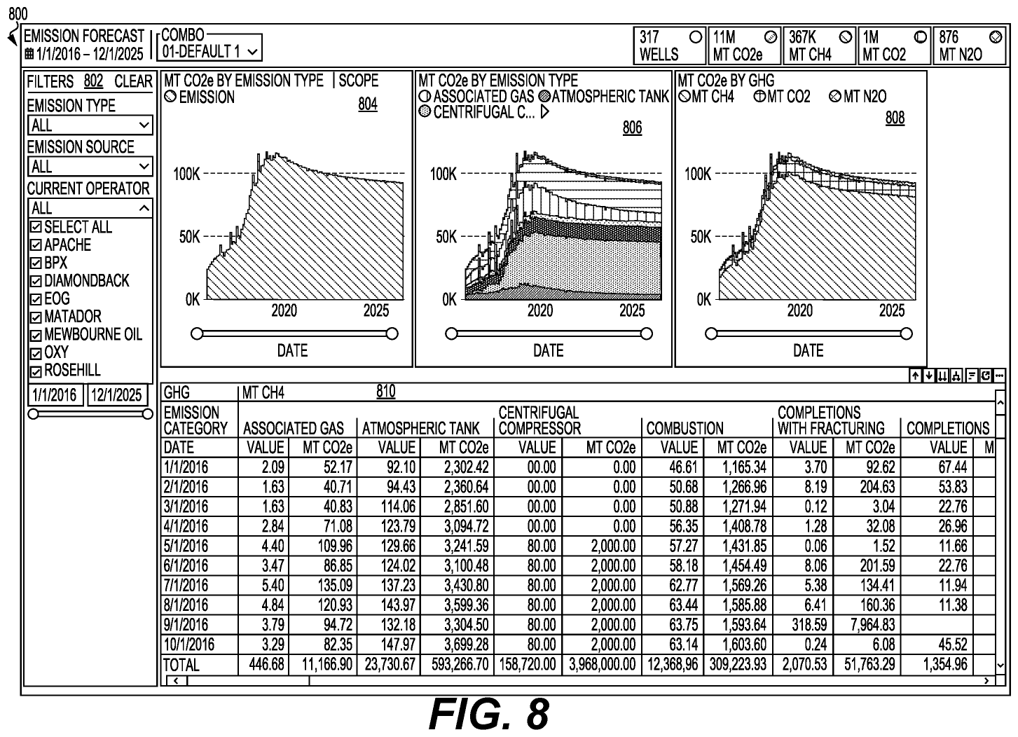

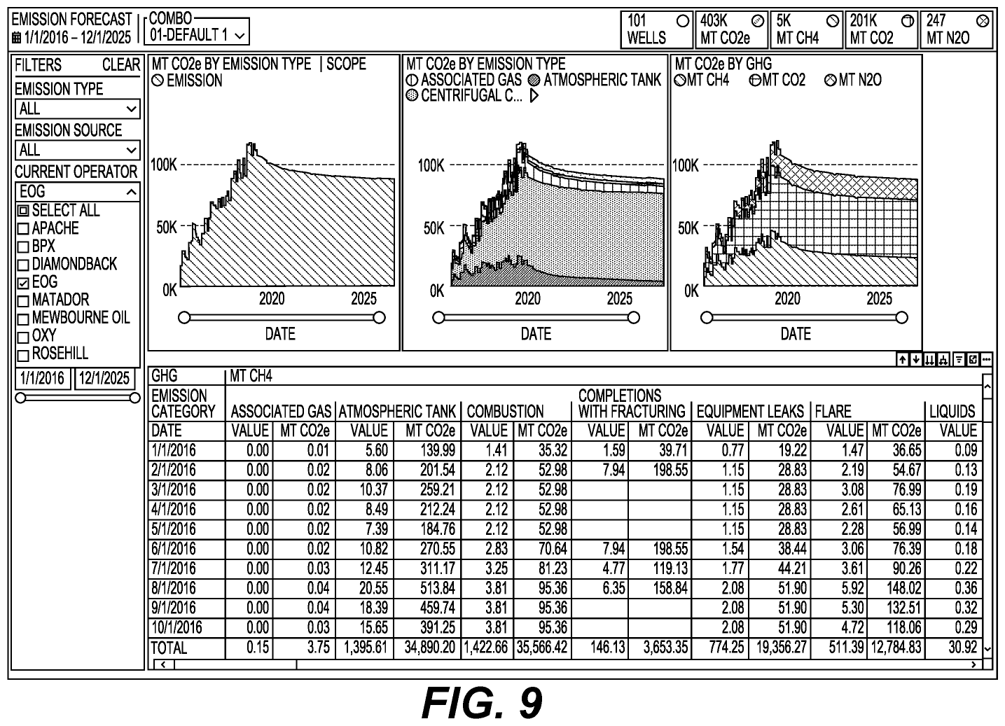

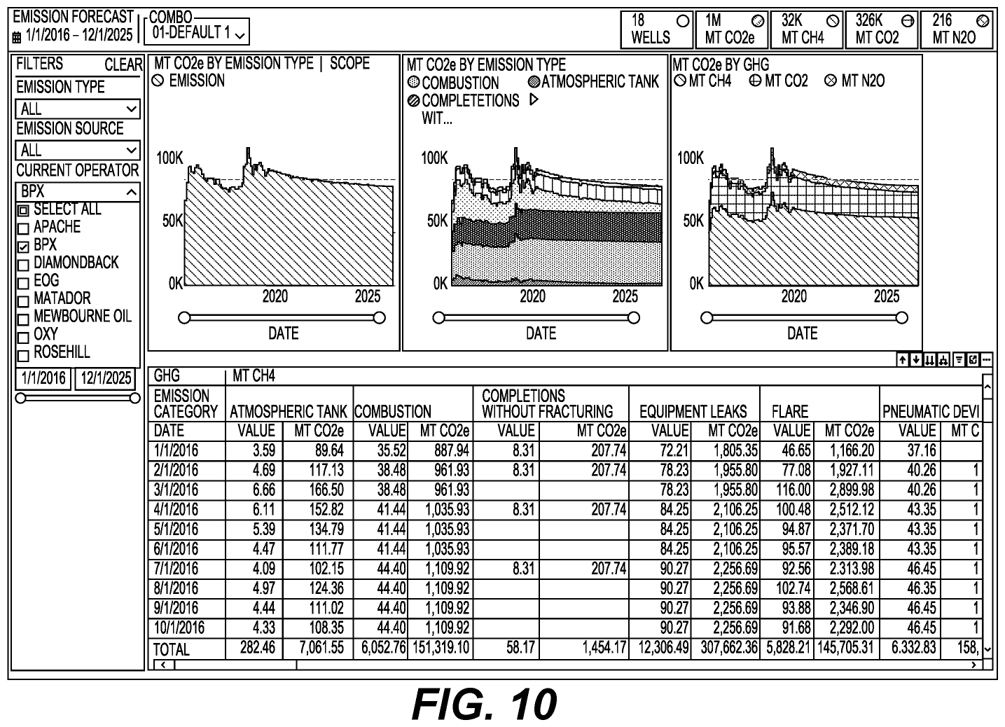

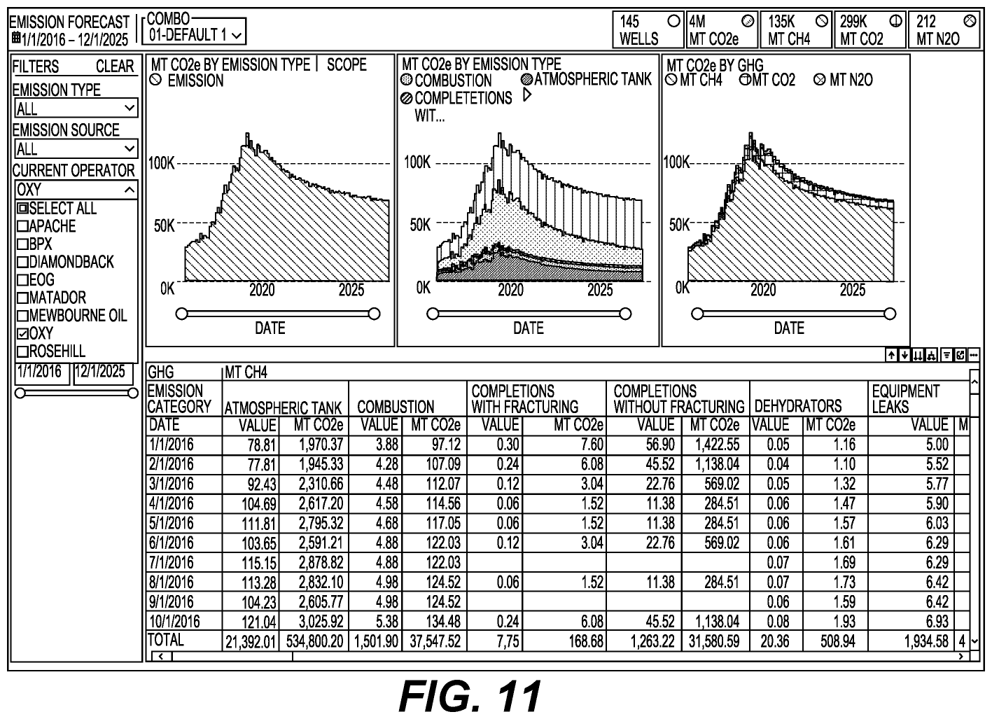

FIGS. 8-18 are screenshots illustrating various emissions data from the interactive top-down emissions model, according to an example embodiment of the present disclosure. For example, FIGS. 8-11 are screenshots of a user interface of the interactive top-down emissions model (e.g., user interface 800) showing emissions forecasts for one or more organizations. As shown in the user interface 800 of FIG. 8, a user may have the option to apply filters 802, for which the user has selected to view all emission types, all emission sources, and all current operators (e.g., organizations), and a filter for selection of a time period over which to illustrate the results (over a time period from Jan. 1, 2016 through Dec. 1, 2025 in this example). This time period of the interactive top-down emissions model (referred to as second time period) may overlap, comprise, or be distinguishable from the individual time periods of the reference emissions report (referred to as first time periods) used to generate the interactive top down emissions model. The user interface 800 also graphically displays metric tons (MT) of CO2e by emission type, emission source, and greenhouse gas (e.g., as shown in graphs 804, 806, and 808). Furthermore, the user interface 800 lists individual emission values for emissions data for each of a plurality of emissions categories (e.g., associated gas, atmospheric tank, centrifugal compressor, combustion, completions with fracturing, etc.) over intervals of time, as shown in Table 810. FIGS. 9-11 also show similar user interfaces as user interface 800 but with different emissions data since the user has decided to apply a filter to only view the emissions data for the organizations EOG, BPX, and Oxy, respectively.

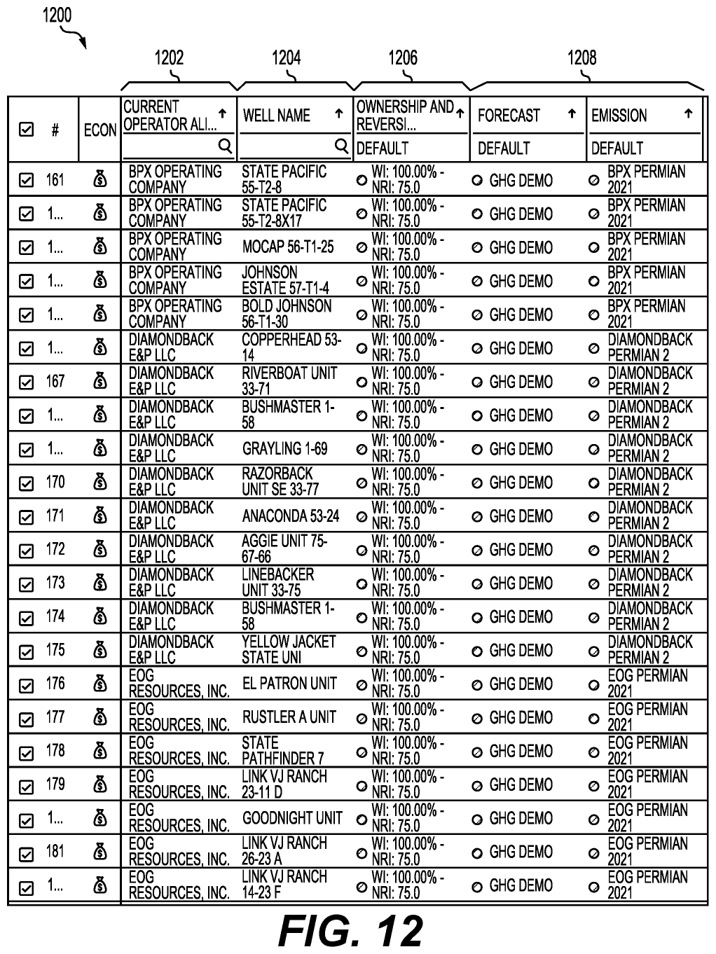

FIG. 12 is a screenshot illustrating an example table 1200 of the interactive top-down emissions model. Table 1200 lists organizations (e.g., current operators as shown in column 1202), wells managed by the organizations (column 1204), ownership information pertaining to the wells (column 1206), as well as links to emissions data in columns 1208-1210. As shown in Table 1200, an organization (e.g., Diamondback E&P LLC) can operate multiple wells. Furthermore, linked emissions data may be able to indicate emissions for a plurality of wells.

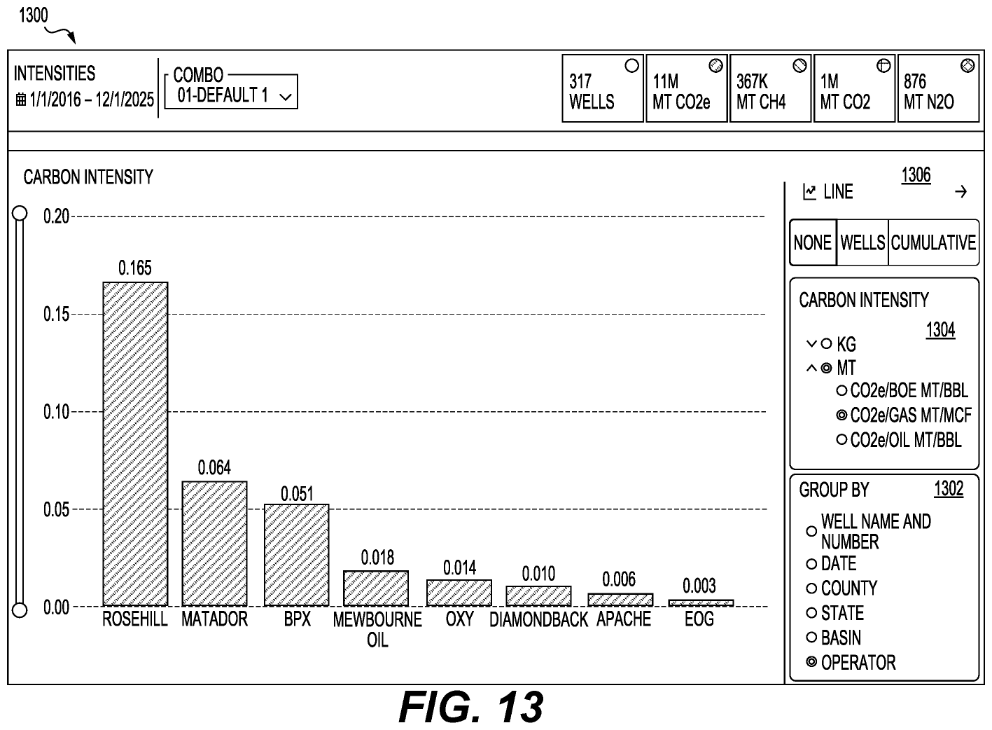

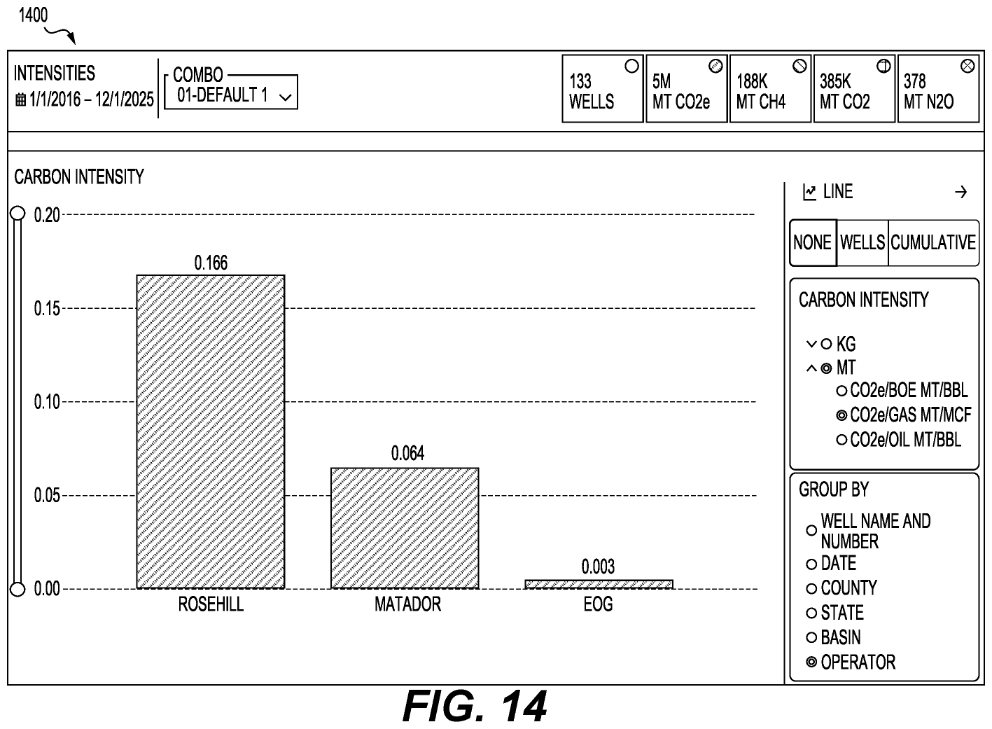

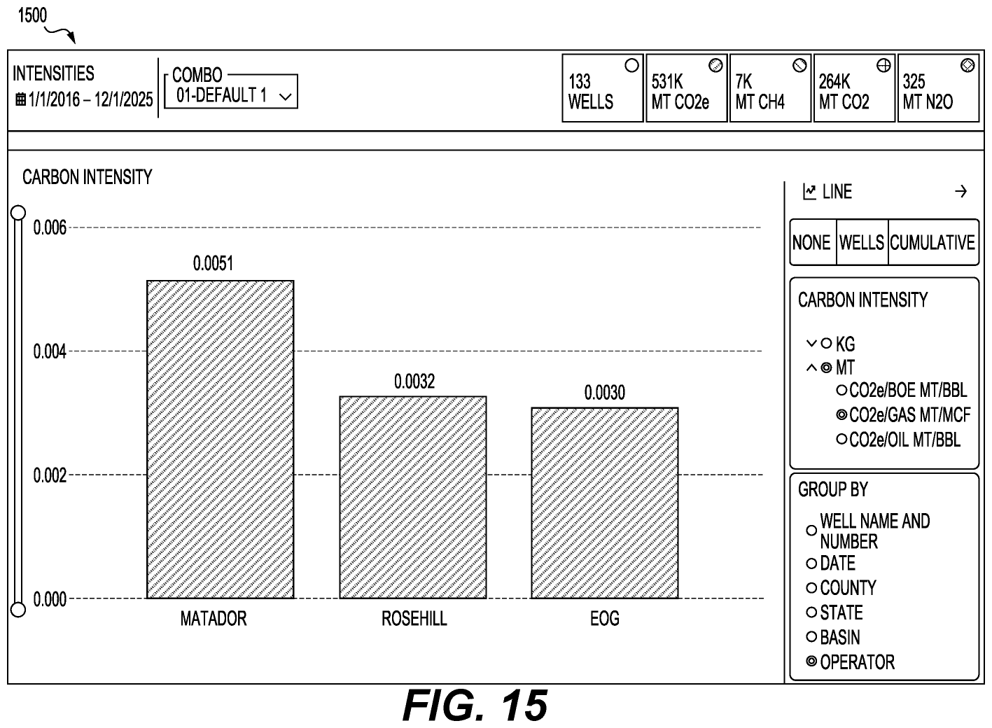

FIGS. 13-15 are screenshots illustrating example graphs 1300-1500, respectively of the interactive top-down emissions mode, comparing the carbon intensity of emissions of various organizations. For example, graph 1300 of FIG. 13 compares the carbon intensity for the organizations Rosehill, Matador, BPX, Newbourne Oil, Oxy, Diamondback, Apache, and EOG, whereas graph 1400 of FIG. 14 compares the carbon intensity for the organizations Matador, Rosehill, and EOG, with their respective top-down emission models while graph 1500 of FIG. 15 compares the carbon intensity for the organizations Matador, Rosehill, and EOG, when EOG top-down emission model is applied to all of them. Although each graph shows carbon intensity for organizations, the screenshots show that the user also has the ability to view carbon intensities based on well name and number, date, county, state, or basin (as shown in box 1302). Furthermore, the user has the ability to view the carbon intensity values in different units (e.g., as shown in box 1304) or view the results as a line graph on a per-well or cumulative basis (e.g., as shown in box 1306).

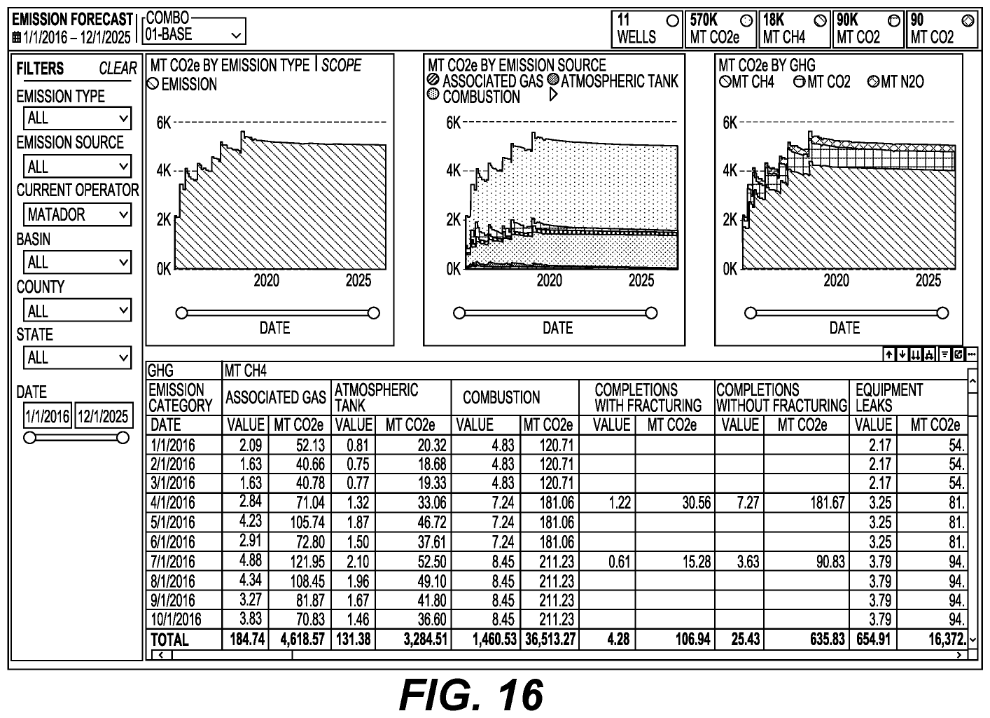

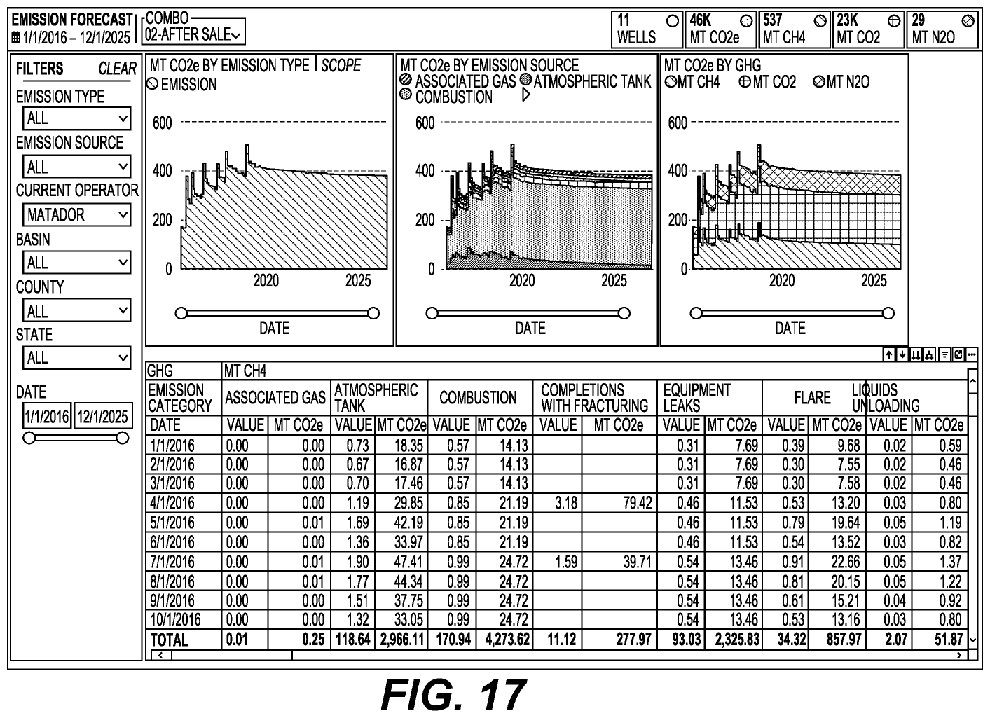

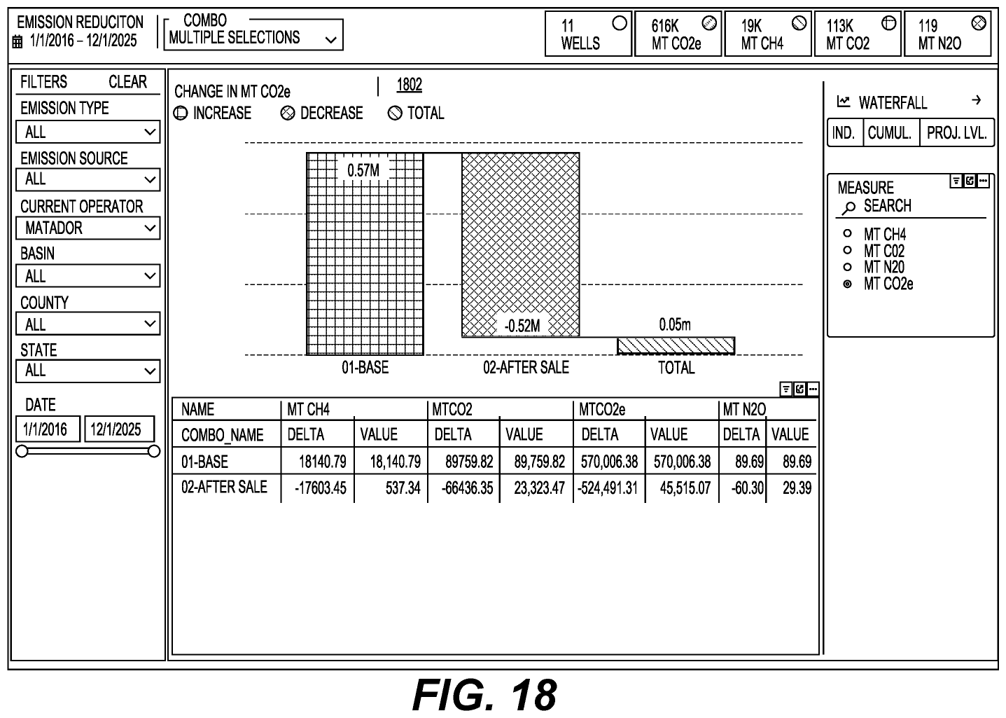

FIGS. 16 and 17 are screenshots of emissions data from the interactive top-down emissions model for the organization Matador, with Matador top-down emission model and EOG top-down emission model, respectively. Such comparison could be used to identify changes in emissions if a company applies all operational and reporting methods implemented by another company as it could happen when a company's asset is acquired by another company. For example, if EOG was to acquire Matador's modeled wells, the emissions data for Matador before the sale (e.g., as shown in FIG. 16) is shown as having higher values for MT CO2 when compared to the emissions data for Matador after the sale to EOG (e.g., as shown in FIG. 17). The difference in emissions value shows that the asset (e.g., a facility and/or equipment) may have generated, and/or contributed to the difference in, the emissions via application of different top-down emission models. FIG. 18 is a screenshot of a graph 1802 of the interactive top-down emissions model showing the difference in emissions level for Matador after changing the top-down emission model to EOG top-down model which could replicate an emission reduction due to application of EOG operational and reporting methods. As shown in the graph 1802, the emission was reduced to 0.05M MT of CO2e (with EOG top-down emission model) from the original value of 0.57M MT of CO2e (with Matador top-down emission model) which represents a difference of 0.52M MT of CO2e that is due to operational and reporting differences between the two companies.

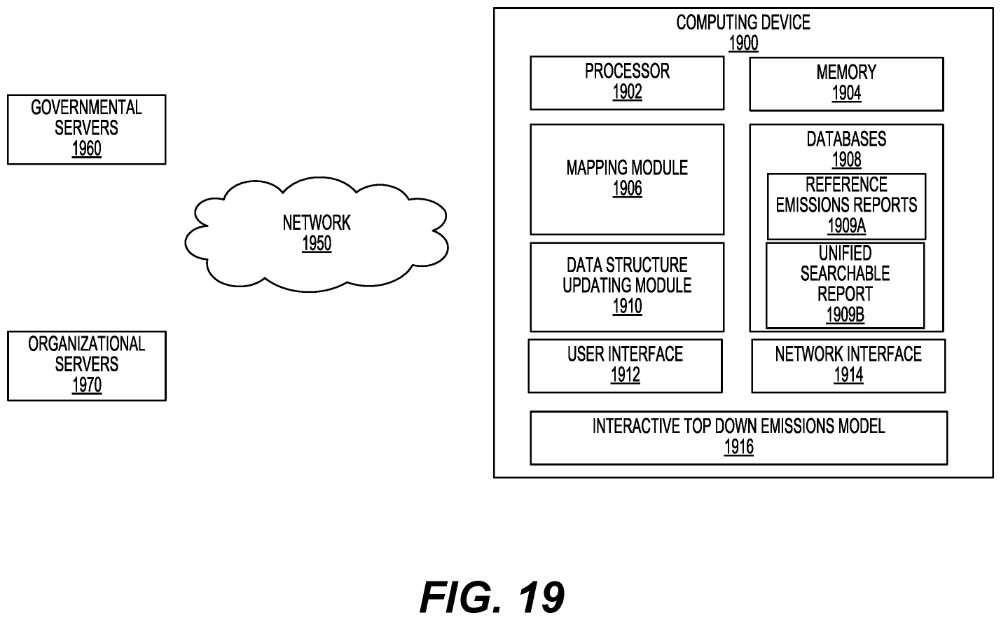

FIG. 19 is a block diagram showing one or more components of an example computing device 1900 and network 1950 used for generating an interactive top-down emissions model in applications, according to an example embodiment of the present disclosure. In some aspects, the computing device 1900 may be used by a user to interact with, use, develop, and/or update the interactive top down emissions mode. For example, the computing device 1900 shown in FIG. 19 may be an example of the computing device used to perform process 100 described in FIG. 1A or provide the user interfaces of FIGS. 2-7, and/or display the screenshots of FIGS. 8-18. As shown in FIG. 19, the computing device 1900 may include, for example, one or more of a processor 1902, a memory 1904, a mapping module 1906, a database 1908, a data structure updating module 1910, a user interface 1912, a network interface 1914, and the interactive top-down emissions model 1916. The network 1950 may be a wired or wireless communication media allowing communication between the computing device 1900 and external servers or external databases, for example governmental servers 1960 (e.g., EPA Public data) and/or organizational servers 1970 (e.g., company servers). For example, the network 1950 may be implemented as a local network (e.g., a local area network), a virtual private network, and/or a global network (e.g., the Internet). The network interface 1914 may comprise one or more wired network interfaces (e.g., Ethernet interfaces) and/or wireless network interfaces (e.g., Wi-Fi®, Bluetooth®, and/or cellular data interfaces) to allow the computing device 1900 to communicate with external devices, servers, and/or databases over the network 1950.

The processor 1902 may comprise any one or more types of digital circuit configured to perform operations on a data stream, including functions described in the present disclosure. The memory 1904 may comprise any type of long term, short term, volatile, nonvolatile, or other memory and is not to be limited to any particular type of memory or number of memories, or type of media upon which memory is stored. Furthermore, the memory 1904 may store computer-executable instructions (e.g., instructions 1905) that, when executed by the processor 1902, can cause the processor 1902 to perform one or more processes described herein.

The mapping module 1906 may comprise any application, program, software, code, or plug-in subcomponent of the computing device 1900 used for mapping, linking, and/or associating (e.g., via metadata stored in data structures) received or stored data corresponding to organizations, facilities, geographies, emissions categories, and/or emissions data to other organizations, facilities, geographies, emissions categories, and/or emissions data. For example, the mapping module may be used to map, using the reference emissions reports and/or any received information on facilities, each organization to one or more basins, and each basin to one or more facilities. Furthermore, the mapping module 1906 may be used to convert emissions and/or production data (e.g., emissions and/or values) to a format required by an emissions category, and/or as desired by a user.

The databases 1908 may comprise one or more repositories of organized data stored in data structures. For example, the databases 1908 may store reference emissions reports 1909A received, for example, from governmental servers 1960 (e.g., EPA Public Database). The databases 1908 may also store any compilations and transformations rendered to the received reference emissions reports 1909A. For example, the databases 1908 may store the unified searchable emissions report 1909B used to form the interactive top-down emissions model 1916 described herein.

The data structure update module 1910 may comprise any application, program, software, code, or plug-in used to allow the computing device 1900 and/or the user to update the one or more databases 1908, including rendering data structures within the database 1908. For example, data structure update module 1910 may allow the computing device 1900 and/or a user to receive, store, and/or compile the reference emissions reports 1909A into a unified searchable report 1909B; map organizations, facilities, geographies, emission categories, and/or emissions data, for example, to eliminate inconsistencies and/or inaccurate reporting; render the unified searchable report as searchable based on any one or more organizations, facilities, geographies, emissions categories, and/or emissions data; as well as provide other functionalities based on the stored data (e.g., graphs, charts, visuals, etc.). Also or alternatively, the data structure update module 1910 may allow the computing device 1900 or the user to update any of the data entries stored in the databases 1908.

The user interface 1912 may comprise any application, program, software, code, or plug-in used to allow a user or operator of the interactive top-down emissions model to view, interact with, update, create, and/or incorporate the interactive top down emissions model, as described herein. Examples and screenshots of the user interface are described, for example, using FIGS. 2-18.

It is contemplated that in various embodiments, one or more of the components of computing device 1900 need not be located within the computing device 1900. For example, the components may be on a server or cloud platform accessible by or provisioned by the computing device 1900.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

1. A method of generating an interactive top-down emissions model, the method comprising:
receiving, by a computing device having a processor, a plurality of reference emissions reports, wherein each reference emissions report is respectively associated with an organization, a basin, and a facility, among a plurality of organizations, a plurality of basins, and a plurality of facilities, respectively, wherein each reference emissions report indicates one or more reference emissions data associated with the organization, the basin, or the facility over a predefined time period;
receiving, by the computing device, facility information indicating, for each of a plurality of facilities, one or both of:
an ownership history of the facility during a first time period, the ownership history indicating ownership of the facility by one or more organizations, among the plurality of organizations, or
a placement history of the facility during the first time period, the placement history indicating an association of the facility with one or more basins among the plurality of basins;
mapping, via a mapping module of the computing device, and based on the plurality of reference emissions reports and the facility information,
each organization, of the plurality of organizations, to one or more basins among the plurality of basins, and
each basin, of the plurality of basins, to one or more facilities among the plurality of facilities;
determine, based on the mapping, aggregate emissions data corresponding to one or more emission categories including associated gas emissions, acid gas removal emissions, liquid unloading emissions, dehydrator emissions, and flare emissions;
determine, based on the mapping, well/production data including a completion well count, a well count, an amount of oil production, and an amount of gas production for each of the plurality organizations, each of the plurality of basins, and each of the plurality of facilities; and
generating, by the computing device, and based on the mapping, the interactive top-down emissions model to forecast for emissions over a future second time period, the interactive top-down emissions model indicating the well/production data and the aggregate emissions data corresponding to the one or more emission categories for each of the plurality organizations, each of the plurality of basins, and each of the plurality of facilities.

2. The method of claim 1, wherein mapping further comprises:
determining, based on the facility information, a change in ownership of a facility from a first organization to a second organization; and
updating the mapping to reflect the change in ownership.

3. The method of claim 1, wherein mapping further comprises:
determining, based on the facility information, a change in placement of a facility from a first basin to a second basin; and
updating the mapping to reflect the change in placement.

4. The method of claim 1, wherein receiving the plurality of reference emissions reports is responsive to one or more user requests for the plurality of reference emissions reports, wherein each user request specifies, for a requested reference emissions report, one or more of:
a desired time period in which reference emissions data of the requested reference emissions report are to be obtained;
an organization to which the requested reference emissions report is to be associated with;
a basin to which the requested reference emissions report is to be respectively associated with; or
an emission category to which the requested reference emissions report is to be respectively associated with.

5. The method of claim 1, further comprising:
generating a functionality to selectively view filtered emissions data from the interactive top-down emissions model, the filtered emissions data associated with:
a subset of emission categories of the one or more emission categories,
a subset of organizations of the plurality of organizations,
a subset of facilities of the plurality of facilities, or
a subset of basins of the plurality of basins; and
displaying, responsive to a user input for selectively viewing the filtered emissions data, the interactive top-down emissions model showing the filtered emissions data.

6. The method of claim 5, wherein the user input for selectively viewing the filtered emissions data comprises toggling, on or off, one or more of an emission category, an organization, a facility, or a basin, from among the one or more emission categories, the plurality of organizations, the plurality of facilities, or the plurality of basins, respectively.

7. The method of claim 1, further comprising:
generating a functionality to selectively input an emission value for an aggregate emission data corresponding to an emission category of the one or more emission categories; and
updating, based on a user input of the emission value for the aggregate emission data, the interactive top-down emissions model.

8. The method of claim 1, further comprising:
generating a functionality to apply a change to a facility setting of a facility, among the plurality of facilities; and
updating, responsive to a user request to apply the change to the facility setting of the facility, the interactive top-down emissions model to reflect a change to a subset of the aggregate emissions data associated with the facility.

9. The method of claim 8, wherein the change to the facility setting comprises one or more of:
an addition or a deletion of an emission category of the one or more emission categories;
a remapping of the facility to another basin based on a change in a placement of the facility; or
a remapping of the facility to another organization based on a change in an ownership of the facility.

10. A system for generating an interactive top-down emissions model, the system comprising:
a processor;
a mapping module; and
a memory storing instructions which, when executed by the processor, cause the processor to:
receive a plurality of reference emissions reports, wherein each reference emissions report is respectively associated with an organization, a basin, or a facility, among a plurality of organizations, a plurality of basins, or a plurality of facilities, respectively, wherein each reference emissions report indicates one or more reference emissions data associated with the organization, the basin, or the facility over a predefined time period;
receive facility information indicating, for each of a plurality of facilities, one or both of:
an ownership history of the facility during a first time period, the ownership history indicating ownership of the facility by one or more organizations, among the plurality of organizations, or
a placement history of the facility during the first time period, the placement history indicating an association of the facility with one or more basins among the plurality of basins;
map, via the mapping module, and based on the plurality of reference emissions reports and the facility information,
each organization, of the plurality of organizations, to one or more basins among the plurality of basins, and
each basin, of the plurality of basins, to one or more facilities among the plurality of facilities;
determine, based on the mapping, aggregate emissions data corresponding to one or more emission categories including associated gas emissions, acid gas removal emissions, liquid unloading emissions, dehydrator emissions, and flare emissions;
determine, based on the mapping, well/production data including a completion well count, a well count, an amount of oil production, and an amount of gas production for each of the plurality organizations, each of the plurality of basins, and each of the plurality of facilities; and
generate, based on the mapping, the interactive top down emissions model to forecast emissions over a future second time period, the interactive top down emissions model indicating the well/production data and the aggregate emissions data corresponding to the one or more emission categories for each of the plurality organizations, each of the plurality of basins, and each of the plurality of facilities.

11. The system of claim 10, wherein the instructions, when executed, cause the processor to map by:
determining, based on the facility information, a change in ownership of a facility from a first organization to a second organization; and
updating the mapping to reflect the change in ownership.

12. The system of claim 10, wherein the instructions, when executed, cause the processor to map by:
determining, based on the facility information, a change in placement of a facility from a first basin to a second basin; and
updating the mapping to reflect the change in placement.

13. The system of claim 10, wherein instruction, when executed, cause the processor to receive the plurality of reference emissions reports in response to one or more user requests for the plurality of reference emissions reports, wherein each user request specifies, for a requested reference emissions report, one or more of:
a desired time period in which reference emissions data of the requested reference emissions report are to be obtained;
an organization to which the requested reference emissions report is to be associated with;
a basin to which the requested reference emissions report is to be respectively associated with; or
an emission category to which the requested reference emissions report is to be respectively associated with.

14. The system of claim 10, wherein the instructions, when executed, further cause the processor to:
generate a functionality to selectively view filtered emissions data from the interactive top-down emissions model, the filtered emissions data associated with:
a subset of emission categories of the one or more emission categories,
a subset of organizations of the plurality of organizations,
a subset of facilities of the plurality of facilities, or
a subset of basins of the plurality of basins; and
display, responsive to a user input for selectively viewing the filtered emissions data, the interactive top-down emissions model showing the filtered emissions data.

15. The system of claim 14, wherein the user input for selectively viewing the filtered emissions data comprises toggling, on or off, one or more of an emission category, an organization, a facility, or a basin, from among the one or more emission categories, the plurality of organizations, the plurality of facilities, or the plurality of basins, respectively.

16. The system of claim 10, wherein the instructions, when executed, further cause the processor to:
generate a functionality to selectively input an emission value for an aggregate emission data corresponding to an emission category of the one or more emission categories; and
update, based on a user input of the emission value for the aggregate emission data, the interactive top-down emissions model.

17. The system of claim 10, wherein the instructions, when executed, further cause the processor to:
generate a functionality to apply a change to a facility setting of a facility, among the plurality of facilities; and
update, responsive to a user request to apply the change to the facility setting of the facility, the interactive top-down emissions model to reflect a change to a subset of the aggregate emissions data associated with the facility.

18. The system of claim 17, wherein the change to the facility setting comprises one or more of:
an addition or a deletion of an emission category of the one or more emission categories;
a remapping of the facility to another basin based on a change in a placement of the facility; or
a remapping of the facility to another organization based on a change in an ownership of the facility.

19. A non-transitory, computer-readable medium storing instructions which, when executed by a processor, cause the processor to:
receive a plurality of reference emissions reports, wherein each reference emissions report is respectively associated with an organization, a basin, or a facility, among a plurality of organizations, a plurality of basins, or a plurality of facilities, respectively, wherein each reference emissions report indicates one or more reference emissions data associated with the organization, the basin, or the facility over a predefined time period;
receive facility information indicating, for each of a plurality of facilities, one or both of:
an ownership history of the facility during a first time period, the ownership history indicating ownership of the facility by one or more organizations, among the plurality of organizations, or
a placement history of the facility during the first time period, the placement history indicating an association of the facility with one or more basins among the plurality of basins;
map, via the mapping module, and based on the plurality of reference emissions reports and the facility information,
each organization, of the plurality of organizations, to one or more basins among the plurality of basins, and
each basin, of the plurality of basins, to one or more facilities among the plurality of facilities;
determine, based on the mapping, aggregate emissions data corresponding to one or more emission categories including associated gas emissions, acid gas removal emissions, liquid unloading emissions, dehydrator emissions, and flare emissions;
determine, based on the mapping, well/production data including a completion well count, a well count, an amount of oil production, and an amount of gas production for each of the plurality organizations, each of the plurality of basins, and each of the plurality of facilities; and
generate, based on the mapping, an interactive top-down emissions model to forecast emissions over a future second time period, the interactive top-down emissions model indicating the well/production data and the aggregate emissions data corresponding to the one or more emission categories for each of the plurality organizations, each of the plurality of basins, and each of the plurality of facilities.

20. The non-transitory computer-readable medium of claim 19, the instructions further comprising:
generate a functionality to selectively view filtered emissions data from the interactive top-down emissions model, the filtered emissions data associated with:
a subset of emission categories of the one or more emission categories,
a subset of organizations of the plurality of organizations,
a subset of facilities of the plurality of facilities, or
a subset of basins of the plurality of basins; and
display, responsive to a user input for selectively viewing the filtered emissions data, the interactive top-down emissions model showing the filtered emissions data.
